(19) United States
(12) Patent Application Publication
(10) Pub. No.: US 2018/0237332 A1
(43) Pub. Date: Aug. 23, 2018

(54) METHOD FOR MANUFACTURING GLASS CHOPPED STRAND AND METHOD FOR MANUFACTURING GLASS CHOPPED STRAND MAT

(71) Applicant: NIPPON ELECTRIC GLASS CO., LTD., Shiga (JP)

(72) Inventors: Akio KIJIMA, Shiga (JP); Kiyomasa SUGIMOTO, Shiga (JP)

(21) Appl. No.: 15/752,175

(22) PCT Filed: Aug. 19, 2016
(86) PCT No.: PCT/JP2016/074245

§ 371 Date: Feb. 12, 2018

(30) Foreign Application Priority Data
Sep. 3, 2015 (JP) 2015-174026

(51) Int. Cl. C03B 37/16; D04H 1/4218

(52) U.S. Cl. CPC C03B 37/16; D10B 2101/06; D04H 1/4218

(57) ABSTRACT

A method for manufacturing glass chopped strands is provided that includes cutting, into a predetermined length, a doubled glass strand that combines glass strands drawn from cakes each of which is formed by winding one of the glass strands. The doubled glass strand, from which the glass chopped strands are manufactured, is formed by combining a first glass strand or strands that are twisted clockwise when drawn from some of the cakes and a second glass strand or strands that are twisted counterclockwise when drawn from the rest of the cakes.

### TECHNICAL FIELD

The present invention relates to a method for manufacturing glass chopped strands by cutting, into a predetermined length, a doubled glass strand that combines a plurality of glass strands and to a method for manufacturing a glass chopped strand mat by matting the glass chopped strands.

### BACKGROUND ART

Conventionally, as a method for manufacturing glass chopped strands, it is known to combine glass strands drawn from a plurality of cakes to form a doubled glass strand and cut the doubled glass strand to obtain glass chopped strands. The glass chopped strands are, for example, deposited into a sheet and bound by a binder to be formed into a glass chopped strand mat (see, for example, Patent Document 1). There is also a method where a doubled glass strand, formed in advance from a plurality of cakes, is wound to form a roving (see, for example, Patent Document 2) and glass chopped strands or a glass chopped strand mat is obtained from the doubled glass strand unwound from the roving.

### PRIOR ART DOCUMENT

### Patent Documents

Patent Document 1: Japanese Laid-Open Patent Publication No. 2011-99190
Patent Document 2: Japanese Laid-Open Patent Publication No. S58-36863

### SUMMARY OF THE INVENTION

### Problems that are to be Solved by the Invention

When glass chopped strands obtained by cutting a doubled glass strand become lumped (bundled), the dispersibility of the glass chopped strands is lowered. That is, in manufacturing a glass chopped strand mat, unevenness arises in the density of the glass chopped strands, and the uniformity of the mat is thereby lowered.

The present invention has been made to solve the above problem and an object thereof is to provide a method for manufacturing glass chopped strands having a satisfactory dispersibility and a method for manufacturing a glass chopped strand mat without unevenness in the density of the glass chopped strands.

### Means for Solving the Problems

In order to solve the above problem and in accordance with one aspect of the present invention, a method for manufacturing glass chopped strands is provided that includes cutting, into a predetermined length, a doubled glass strand that combines glass strands drawn from cakes each of which is formed by winding one of the glass strands. The doubled glass strand, from which the glass chopped strands are manufactured, is formed by combining a first glass strand or strands that are twisted clockwise when drawn from some of the cakes and a second glass strand or strands that are twisted counterclockwise when drawn from the rest of the cakes.

With the present method, by combining the first glass strand or strands that are twisted clockwise and the second glass strand or strands that are twisted counterclockwise, the doubled glass strand is put in a state where the glass strands having the two different types of twist of clockwise and counterclockwise coexist together. The glass chopped strands, obtained by subsequently cutting the doubled glass strand into the predetermined length, thus have a satisfactory dispersibility.

In the method for manufacturing glass chopped strands, it is preferable for the percentage of the number of the first glass strand or strands with respect to the total number of the first glass strand or strands and the second glass strand or strands in the doubled glass strand to be 25 to 75%.

With the present method, the glass strands having the two different types of twist coexist together at appropriate proportions in the doubled glass strand, therefore contributing to improvement of the dispersibility when the doubled glass strand is subsequently cut into the glass chopped strands.

In the method for manufacturing glass chopped strands, it is preferable for the cakes to be divided filament cakes.

Among cakes, there are a cake (hereinafter referred to as single filament cake) formed by winding, around a single collet, a glass strand that is formed by combining, into a single strand, a plurality of glass monofilaments drawn from a single bushing having several dozen to several thousand nozzles and a divided filament cake, formed by winding, around a single collet, glass strands that are formed by combining, into a plurality of strands, a plurality of glass monofilaments drawn from a single bushing. The variation of length among the glass monofilaments constituting a single glass strand wound in a divided filament cake is small in comparison to the variation of length among the glass monofilaments that constitute the single glass strand wound in a single filament cake. Therefore, with a divided filament cake, there is little entanglement of glass monofilaments with each other. By the present method, the doubled glass strand obtained from the divided filament cakes is cut and therefore the glass chopped strands are improved in dispersibility.

In accordance with another aspect of the present invention, a method for manufacturing a glass chopped strand mat is provided that includes depositing the glass chopped strands manufactured by the above-described method into a sheet and then binding the glass chopped strands to each other to manufacture the glass chopped strand mat.

With the present method, since the glass chopped strand mat is manufactured using the glass chopped strands manufactured from the doubled glass strand in which the glass strands having the two different types of twist of clockwise and counterclockwise coexist and are combined, it is possible to obtain a glass chopped strand mat of high uniformity without unevenness in the density of the glass chopped strands.

### Effects of the Invention

With the method for manufacturing glass chopped strands according to the present invention, glass chopped strands having an improved dispersibility can be obtained, and with the method for manufacturing a glass chopped strand mat according to the present invention, a glass chopped strand mat that is without unevenness in density can be obtained.

Other aspects and merits of the present invention shall be made clear from the following description together with the drawings that illustrate an example of the technical ideas of the present invention.

### BRIEF DESCRIPTION OF THE DRAWINGS

FIG. 1 is a schematic view for describing a method for manufacturing glass chopped strands (mat) according to a first embodiment.

FIG. 2(a) is a schematic view for describing a method for manufacturing glass chopped strands (mat) according to a second embodiment and shows a pre-process before manufacturing a roving, FIG. 2 (b) is similarly a schematic view for describing the method for manufacturing glass chopped strands (mat) according to the second embodiment and shows a post-process after the manufacture of the roving.

FIG. 3 is a schematic view for describing forming of a doubled glass strand according to another embodiment.

### MODES FOR CARRYING OUT THE INVENTION

### First Embodiment

Methods for manufacturing glass chopped strands and a glass chopped strand mat will now be described.

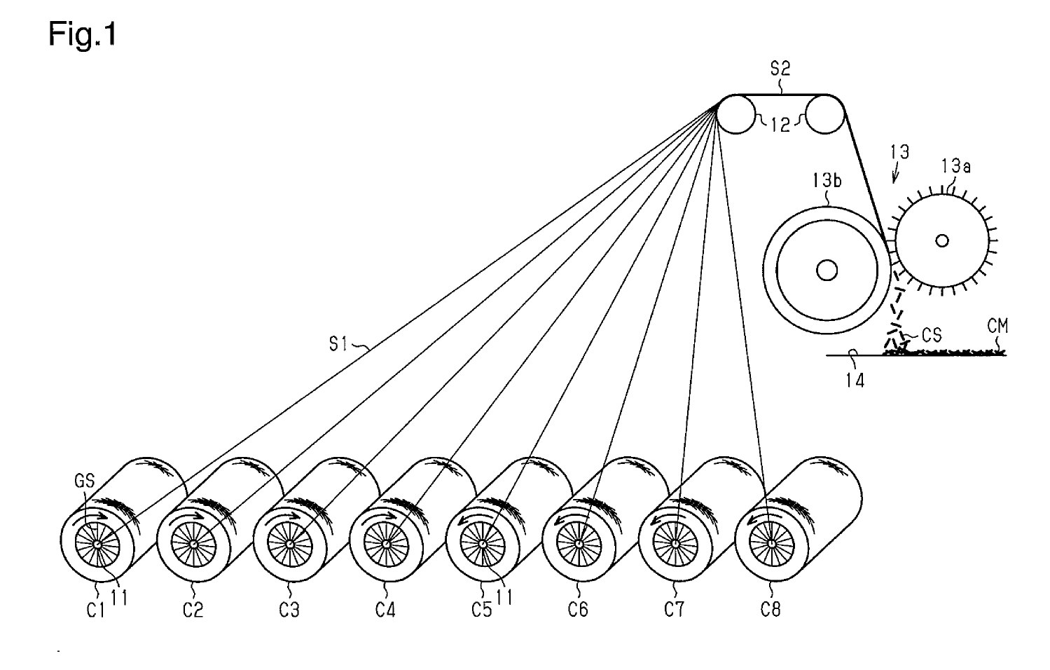

As shown in FIG. 1, eight cylindrical cakes C1 to C8 are used in manufacturing glass chopped strands CS and a glass chopped strand mat CM of the present embodiment. The cakes C1 to C8 have winding shafts extending parallel to a floor surface, that is, in a horizontal direction and are arranged so as to be parallel to each other. Each of the cakes C1 to C8 is a so-called divided filament cake in which sixteen glass strands GS are wound.

Each divided filament cake is manufactured as follows. First, molten glass is drawn from a bushing nozzle having several dozen to several thousand nozzles to form glass monofilaments corresponding to the number of nozzles. Next, sixteen glass strands are prepared, each by combining one-sixteenth of the total number of glass monofilaments and applying a sizing agent, and the sixteen glass strands are wound around a single collet. Lastly, the collet is pulled out.

Sixteen glass strands GS are drawn at the same time from the inner part of each of the cakes C1 to C8. A drawing portion 11 is provided at one end of the winding shaft of each of the cakes C1 to C8, and a glass strand S1, in which the sixteen glass strands GS are made into one, is drawn from each drawing portion 11.

With the present embodiment, the winding direction of some of the cakes C1 to C8 differs from the winding direction of the rest of the cakes. Specifically, cakes C1 to C4 are first cakes in which the glass strands GS are wound clockwise as viewed from the drawing portion 11 side (that is, the glass strands GS are drawn clockwise from the inner circumference) and cakes C5 to C8 are second cakes in which the glass strands GS are wound counterclockwise as viewed from the drawing portion 11 side (that is, the glass strands GS are drawn counterclockwise from the inner circumference). In the present description, the glass strands GS that are drawn and twisted from the first cakes shall be denoted as first glass strands and the glass strands GS that are drawn and twisted from the second cakes shall be denoted as second glass strands. That is, since although twisting is applied to the glass strand S1 drawn from each of the cakes C1 to C8, the direction of winding as viewed from the drawing portion 11 side differs between the cakes C1 to C4 and the cakes C5 to C8, glass strands (first glass strands and second glass strands) that differ in twist direction coexist together.

At guide portions 12, the glass strands S1, which have been drawn and twisted from the respective cakes C1 to C8 through the drawing portions 11, are combined into a doubled glass strand S2 and guided to a cutting apparatus 13. At the cutting apparatus 13, the doubled glass strand S2 is put in between blade portions of a cutter roll 13a and an outer peripheral surface of an elastic roll 13b to cut the doubled glass strand S2 into glass chopped strands CS with a length of 10 to 100 mm.

The winding direction (drawing direction) as viewed from the drawing portion 11 side differs between the cakes C1 to C4 and the cakes C5 to C8 and therefore glass strands S1 having two different types of twist, that is, glass strands (first glass strands) twisted in the clockwise direction and glass strands (second glass strands) twisted in the counterclockwise direction coexist together in the doubled glass strand S2. Consequently, the glass chopped strands CS, obtained by cutting the doubled glass strand S2, are satisfactory in dispersibility. This is presumed to be because the glass strands S1 differ mutually in twist direction and the dispersibility of the glass chopped strands CS is thus improved by actions of forces in directions in which twist is released after cutting.

The glass chopped strands CS are then formed into a glass chopped strand mat CM by undergoing a process of, for example, spraying a binder, while being conveyed downstream by a conveying apparatus 14. With the present embodiment, due to the improvement of the dispersibility of the glass chopped strands CS, there is no unevenness in the density of the glass chopped strand mat CM and improvement of uniformity is achieved.

Incidentally, with a comparative example of glass chopped strands CS in which all eight cakes C1 to C8 are first cakes (cakes with the winding direction of the glass strands GS as viewed from the drawing portion 11 side being clockwise), the rate of occurrence of defective dispersion was 20%. On the other hand, with the present embodiment, the rate of occurrence of defective dispersion was not more than 5%, which was a significant decrease.

Next, characteristic effects of the present embodiment will be described.

(1) By combining the first glass strands that are drawn and twisted from the cakes C1 to C4 (first cakes) and the second glass strands that are drawn and twisted from the cakes C5 to C8 (second cakes), the doubled glass strand S2 is put in a state where the glass strands S1 having the two different types of twist of clockwise and counterclockwise coexist together. The glass chopped strands CS, obtained by subsequently cutting the doubled glass strand S2 into a predetermined length, thus have a satisfactory dispersibility. Also, the glass chopped strand mat CM, manufactured using the glass chopped strands CS, is high in uniformity.

(2) Due to the number of the first glass strands and the number of the second glass strands in the doubled glass strand S2 being the same as each other, the glass strands S1 having the two different types of twist of clockwise and counterclockwise coexist together at appropriate proportions in the doubled glass strand S2, therefore contributing to improvement of the dispersibility when the doubled glass strand S2 is subsequently formed into the glass chopped strands CS.

### Second Embodiment

A method by which a doubled glass strand is formed from cakes, a roving is formed by winding the doubled glass strand, and glass chopped strands and a glass chopped strand mat are manufactured from the roving will now be described.

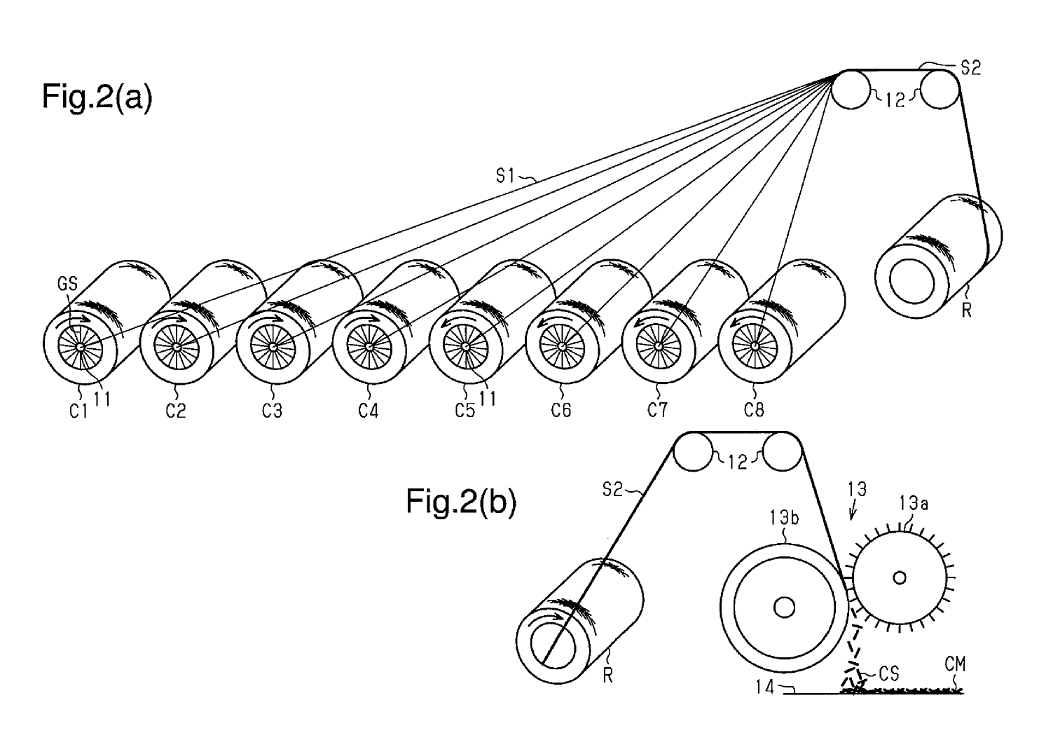

As shown in FIG. 2 (a), the method of the present embodiment includes the forming of a roving R. That is, glass strands S1 are drawn from cakes C1 to C4, which are first cakes in which glass strands GS are wound clockwise as viewed from a drawing portion 11 side, and cakes C5 to C8, which are second cakes in which glass strands GS are wound counterclockwise as viewed from the drawing portion 11 side, and formed into a single doubled glass strand S2 via guide portions 12 and then wound. The wound body thus obtained is the roving R. The doubled glass strand S2, which is wound and forms the roving R, is in a state where the glass strands S1 having the two different types of twist of clockwise and counterclockwise coexist together.

Subsequently, as shown in FIG. 2 (b), the doubled glass strand S2 is drawn from the roving R and guided via guide portions 12 to a cutting apparatus 13 to manufacture glass chopped strands CS and a glass chopped strand mat CM in the same manner as in the first embodiment. By using the roving R, formed by winding the doubled glass strand S2, in which the glass strands S1 having the two different types of twist coexist together, the dispersibility of the glass chopped strands CS is satisfactory and the uniformity of the glass chopped strand mat CM is also satisfactory as in the first embodiment.

Next, characteristic effects of the present embodiment will be described.

(1) The glass chopped strands CS having a satisfactory dispersibility can be obtained and the glass chopped strand mat CM that is without unevenness in density and is high in uniformity can also be obtained because the roving R is manufactured from the doubled glass strand S2, in which the glass strands S1 having the two different types of twist coexist together, and the glass chopped strands CS are manufactured from the doubled glass strand S2 drawn from the roving R.

(2) Due to being of a mode of using the roving R formed by winding the doubled glass strand S2, a pre-process before the manufacture of the roving R and a post-process after the manufacture of the roving R can be arranged at separate, independent manufacturing lines.

The embodiments described above may be changed as follows.
Although in each of the embodiments described above, all of the cakes C1 to C8 are laid out so that the winding shafts extend in the horizontal direction, the layout is not restricted thereto. For example, all of the cakes C1 to C8 may be laid out so that the winding shafts extend in a vertical direction. Alternatively, the direction may be oblique instead of being horizontal or vertical.

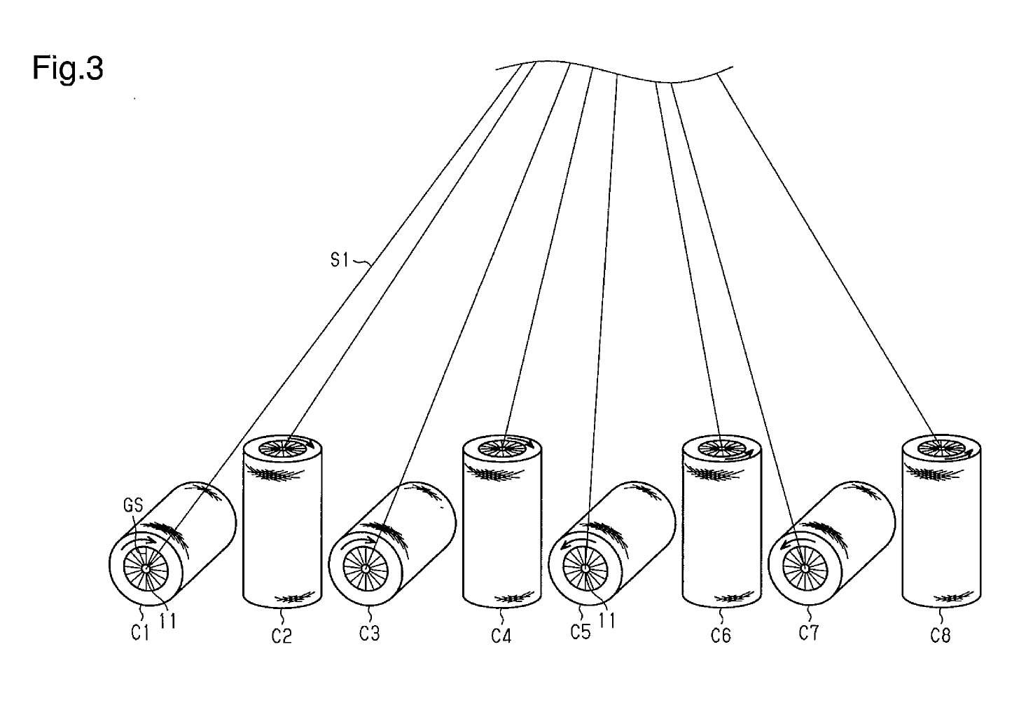

Alternatively, as shown in FIG. 3, the cakes C1 to C8 may be laid out so that winding shafts extending in the horizontal direction and those extending in the vertical direction alternate. That is, the directions in which the winding shafts of the cakes C1 to C8 extend do not have to be aligned in a single direction.
Although the glass chopped strands CS are manufactured from the eight cakes C1 to C8 in the first embodiment described above and the roving R (and thereafter the glass chopped strands CS) is manufactured from the eight cakes C1 to C8 in the second embodiment described above, the number of cakes may be less than eight or may be greater than eight.
Although in each of the embodiments described above, each of the cakes C1 to C8 is a divided filament cake, in which sixteen glass strands GS are wound, the number of glass strands GS wound in each of the cakes C1 to C8 may be greater than sixteen or may be less than sixteen.
Although in each of the embodiments described above, the first cakes (cakes C1 to C4) and the second cakes (cakes C5 to C8) are equal to each other in number, these do not have to be equal in number. However, it is preferable for the number of either of the first and second cakes to be 25 to 75% of the total number of first and second cakes.
Although in each of the embodiments described above, the layout is such that four juxtaposed first cakes (cakes C1 to C4) are positioned next to four juxtaposed second cakes (cakes C5 to C8), the layout is not restricted thereto. For example, the first cakes and the second cakes may be laid out alternately.
Although in each of the embodiments described above, the drawing portions 11 are installed, the drawing portions 11 do not have to be installed. In this case, with the cakes C1 to C4, the glass strands GS are drawn clockwise when the cakes are viewed from the side at which the glass strands GS are drawn, and with the cakes C5 to C8, the glass strands GS are drawn counterclockwise when the cakes are viewed from the side at which the glass strands GS are drawn. At the guide portions 12, the glass strands GS are combined into the doubled glass strand S2 and guided to the cutting apparatus 13.

The present invention is not limited to the examples disclosed. For example, the exemplified features should not be understood as being essential to the present invention, and rather, the subject matter of the present invention may exist in fewer features than all features of a specific embodiment disclosed. The present invention is defined by the claims and intended to cover all modifications within the scope of the claims and the scope of equivalents.

### DESCRIPTION OF THE REFERENCE NUMERALS

11: drawing portion, C1 to C4: cake (first cake), C5 to C8: cake (second cake), GS: glass strand, S1: glass strand, S2: doubled glass strand, CS: glass chopped strands, CM: glass chopped strand mat.

1. A method for manufacturing glass chopped strands, the method comprising cutting, into a predetermined length, a doubled glass strand that combines glass strands drawn from cakes each of which is formed by winding one of the glass strands,
wherein the doubled glass strand, from which the glass chopped strands are manufactured, is formed by combining a first glass strand or strands that are twisted clockwise when drawn from some of the cakes and a second glass strand or strands that are twisted counterclockwise when drawn from the rest of the cakes.

2. The method according to claim 1, wherein the percentage of the number of the first glass strand or strands with respect to the total number of the first glass strand or strands and the second glass strand or strands in the doubled glass strand is 25 to 75%.

3. The method according to claim 1, wherein the cakes are divided filament cakes.

4. A method for manufacturing a glass chopped strand mat, comprising depositing the glass chopped strands manufactured by the method according to claim 1 into a sheet and then binding the glass chopped strands to each other to manufacture the glass chopped strand mat.
